(19) United States
(12) Patent Application Publication
(10) Pub. No.: US 2002/0162579 A1
(43) Pub. Date: Nov. 7, 2002

(54) Wet stripping apparatus and method of using

(75) Inventors: Yu-Hsi Wang, Taichung (TW); Wen-Hxiang Tseng, Hsinchu (TW); Wei-Jen Huang, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 09/847,511

(22) Filed: May 2, 2001

(51) Int. Cl. B08B 3/00

(52) U.S. Cl. 134/26; 134/32; 134/105; 134/902; 134/137

(57) ABSTRACT

A wet stripping apparatus for removing unwanted film layers, such as a thick photoresist layer from a wafer surface after a solder bumping process and a method for using the apparatus are disclosed. The apparatus includes a tank body, a wafer holder, and a means for reciprocally moving the wafer holder in an up-and-down motion with at least one wafer mounted in the holder immersed in a stripper solution to a frequency of not higher than 100 cycle/min. The stripper solution utilized, which is suitably kept at a temperature of at least 50° C., contains dimethyl sulfoxide, tetramethyl-ammonium-hydroxide and water. After the stripping process, the wafer is rinsed in a quick dump rinse step and then spin dried for conducting subsequent fabrication processes on the wafer.

### FIELD OF THE INVENTION

The present invention generally relates to a wet stripping apparatus and a method of using and more particularly, relates to a wet stripping apparatus capable of moving reciprocally in a stripper solution for removing thick photoresist layers from the wafer surface and a method for using the apparatus.

### BACKGROUND OF THE INVENTION

In the fabrication of semiconductor devices, various processing steps are started with a photolithographic process to first define a circuit on the wafer. For instance, in a modern memory device, multiple layers of metal conductors are required for providing a multi-layer metal interconnect structure. As the number of layers of metal interconnects increase, while the device geometry continuously decreases to allow more densely packed circuits, the photolithographic process required to define patterns of circuits becomes more complicated and difficult to carry out.

After a process for forming metal vias or lines in an insulating layer is completed, a photoresist layer must be stripped. As a result, it is necessary to subject the wafer to a wet etching process. For instance, a wet stripping process can be implemented after a photoresist dry stripping process by utilizing a wet etchant such as ACT® 690C or EKC® 265 in order to remove the photoresist layers. The ACT® 690C is a mixture of DMSO (dimethyl-sulphur-oxide), MEA (mono-ethyl-amine) and catechol, while EKC® 265 is a mixture containing HDA (hydroxy-amine). The conventional wet dip process requires a special buffer solvent treatment step in order to avoid or minimize metal corrosion problems in the circuits already formed on the wafer surface.

Wet etching is the more frequently used technique for stripping photoresist films from silicon wafers where the complete removal of resist images without adversely affecting the wafer surface is desired. The resist layer or images should be completely removed without leaving any residues, including contaminant particles that may have been present in the resist. The underlying surface of the photoresist layer should not be adversely affected, for instance, accidental etching of the metal or oxide surface should be avoided. Liquid etchant strippers should produce a reasonable bath yield in order to prevent redeposition of dissolved resist on the wafers. The etchant should completely dissolve the photoresist layer in a chemical reaction, and not just lifting or peeling so as to prevent redeposition. It is also desirable that the etching or stripping time be reasonably short in order to permit high wafer throughput.

Other wet etchants such as sulfuric acid (H₂SO₄) and mixtures of H₂SO₄ with other oxidizing agents such as hydrogen peroxide (H₂O₂) may also be used in stripping photoresist or in cleaning a wafer surface after the photoresist has been stripped by other means. For instance, a mixture may be seven parts H₂SO₄ to three parts 30% H₂O₂, or a mixture of 88% sulfuric acid and 12% nitric acid. Wafers to be stripped can be immersed in the mixture at a temperature between about 100° C. and about 150° C. for 5˜10 minutes and then subjected to a thorough rinse of deionized water and dried in dry nitrogen. This type of inorganic resist strippers, such as the sulfuric acid mixtures, is very effective in the residual-free removal of highly post-baked resist. They are more effective than organic strippers and the longer the immersion time, the cleaner and more residue-free wafer surface can be obtained.

A conventional wet dip process is shown in a flow chart 10 shown in FIG. 1. In the conventional wet dip process for removing a photoresist or polymer layer from a surface of a wafer 12, the wafer is first dipped into an ACT bath 14 for conducting a first etch reaction. The ACT solution is normally maintained at a temperature higher than room temperature. After a suitable time period of immersing in the ACT solution, the wafer 12 is moved to the second ACT bath 16 and again immersed for a suitable length of time. The wafer 12 is then immersed in a buffer solvent bath 18 to substantially neutralize the residual acid solution on the wafer surface. The buffer solvent bath 18 may contain a solvent such as isopropyl alcohol or an NMP. The wafer 12 is immersed in the buffer solvent for a sufficient length of time so as to neutralize all residual acid on the wafer surface. The immersing time in the buffer solvent is at least 10 minutes. The wafer 12 is then moved to a quick dump rinse tank 20 for a quick dump rinse by deionized water. The quick dump rinse process is followed by a final rinse carried out in a final rinse bath 22 with deionized water. After the wafer 12 is thoroughly rinsed, it is dried in a drying tank 24.

The conventional photoresist or polymer strip process shown in FIG. 1 requires the neutralizing step of immersing in the buffer solvent bath 18. Since the buffer solvent bath 18 is kept at a temperature similar to that of the ACT bath 16, i.e. at a temperature somewhat higher than 100° C., any incomplete neutralized acid left on the wafer surface can be very active at such temperature for reacting with metal lines or vias formed on the wafer surface. Such reaction leads to the corrosion of metal lines or vias and subsequently, resulting in serious defects or failure in the circuit formed on the wafer surface.

FIG. 2 is a detailed, cross-sectional view of the conventional etch tanks 14,16 shown in FIG. 1. The wafer 12 is substantially submerged in an etchant 28 that is sprayed into the chamber cavity 30 through at least two spray nozzles 32. At least one wafer 12 is positioned in a wafer holder 34 that is supported by the bottom wall 36 of the etch tank 14,16. The etchant spray is fed from a heated reservoir tank 38 through a pump 26 and a filter 42. The etchant spray 40, while effective in improving the circulation of the etchant 28 in the tank cavity 30, does not in itself supply sufficient kinetic energy for removing the photoresist layers from the wafer surface. The removal of a thick photoresist layer after a solder bumping process is even more difficult when the photoresist layer is used as a mold for the formation of solder bumps.

It is therefore an object of the present invention to provide a wet stripping apparatus for removing unwanted film layers from a wafer surface that does not have the drawbacks or shortcomings of the conventional wet stripping apparatus.

It is another object of the present invention to provide a wet bench apparatus for removing unwanted film layers from a wafer surface that provides improved fluid circulation in the etch tank.

It is a further object of the present invention to provide a wet bench apparatus for removing unwanted film layers from a wafer surface that is equipped with means for reciprocally moving a wafer in an up-and-down motion while immersed in the stripper solution.

It is another further object of the present invention to provide a wet stripping apparatus for removing a photoresist layer from a wafer surface after a bumping process.

It is still another object of the present invention to provide a wet stripping apparatus for removing unwanted film layers from a wafer surface by reciprocally moving a wafer immersed in a stripper solution at a frequency of not higher than 100 cycle/min.

It is yet another object of the present invention to provide a method for removing unwanted film layers from a wafer surface by wet stripping wherein a wafer is moved reciprocally in an up-and-down motion while immersed in a stripper solution.

### SUMMARY OF THE INVENTION

In accordance with the present invention, a wet stripping apparatus for removing unwanted film layers from a wafer surface and a method for using the apparatus are disclosed.

In a preferred embodiment, a wet stripping apparatus for removing unwanted film layers from a wafer surface is provided which includes a tank body for holding a volume of a stripper solution therein; a wafer holder for holding at least one wafer therein in a vertical position such that a planar surface of the wafer is parallel to a vertical tank wall of the tank body; and means for reciprocally moving the wafer holder in an up-and-down motion with the at least one wafer immersed in the stripper solution at a frequency of not higher than 100 cycle/min.

The wet stripping apparatus for removing unwanted film layers from a wafer surface may further include heating means in the tank body for heating the stripper solution. The wafer holder may be a front open unified pod (FOUP) for holding up to twentyfive wafers. The wafer holder may also be a standard mechanical interface (SMIF) pod. The means for reciprocally moving the wafer holder may be an air cylinder assembly, or may be an air cylinder assembly that moves at a frequency of about 60 cycle/min. The heating means may be an electrical heating means, while the stripper solution may include dimethyl sulfoxide (DMSO).

The present invention is further directed to a method for removing unwanted film layers from a wafer surface by wet stripping which can be carried out by the operating steps of providing a tank body and filling the tank body with a volume of a stripper solution; providing a wafer holder for holding at least one wafer therein in a vertical position with a planar surface of the wafer parallel to a vertical tank wall of the tank body; mounting the wafer holder in the tank body immersed in the stripper solution; and moving the wafer holder reciprocally in an up-and-down motion with the at least one wafer immersed in the stripper solution at a frequency of not more than 100 cycle/min.

The method for removing unwanted film layers from a wafer surface by wet stripping may further include the step of filling the tank body with a stripper solution that includes dimethyl sulfoxide, or a stripper solution that includes dimethyl sulfoxide and tetramethyl ammonia hydroxide. The method may further include the step of mounting the wafer holder in the tank body and soaking the at least one wafer in the stripper solution stationarily for at least 3 min., or the step of mounting the wafer holder in a tank body and soaking the at least one wafer in the stripper solution stationarily for at least 3 min. and then moving the wafer holder up-and-down at a frequency of not more than 100 cycle/min.

The method for removing unwanted film layers from a wafer surface by wet stripping may further include the steps of rinsing the wafer holder and the at least one wafer in a quick dump rinse (QDR) process; and spin drying the at least one wafer. The method may further include the step of removing the wafer holder reciprocally in an up-and-down motion for a length of time sufficient to remove all unwanted film layers from the wafer surface.

The present invention is further directed to a method for removing unwanted photoresist layers from a wafer surface by wet stripping which can be carried out by first providing a tank body and filling the tank body with a volume of a stripper solution; then providing a wafer holder for holding at least one wafer therein in a vertical position with a planar surface of the wafer parallel to a vertical tank wall of the tank body; mounting the wafer holder in the tank body and immersing the at least one wafer stationarily in the stripper solution for a time period of at least 3 min; and moving the wafer holder reciprocally in an up-and-down motion with the at least one wafer immersed in the stripper solution at a frequency of not higher than 100 cycle/min.

The method for removing unwanted film layers from a wafer surface by wet stripping may further include the step after the moving step of immersing the at least one wafer stationarily in the tank body for a time period of at least 10 sec. The method may further include the step of filling the tank body with a stripper solution that contains dimethyl sulfoxide. The method may further include the steps of rinsing the wafer holder and the at least one wafer in a quick dump rinse process; and spin drying the at least one wafer. The method may further include the step of moving the wafer holder reciprocally in an up-and-down motion for a length of time sufficient to remove all unwanted film layers from the wafer surface.

### BRIEF DESCRIPTION OF THE DRAWINGS

These and other objects, features and advantages of the present invention will become apparent from the following detailed description and the appended drawings in which:

FIG. 1 is a flow chart illustrating a conventional wet stripping process for a semiconductor wafer.

FIG. 2 is a cross-sectional view of an etch tank for the conventional wet stripping process of FIG. 1.

FIGS. 3A-3E are enlarged, cross-sectional views of a present invention bumping process that incorporates the photoresist layer stripping process.

FIG. 4 is a cross-sectional view of the present invention apparatus incorporating an air cylinder assembly for moving a wafer holder reciprocally in an up-and-down motion in the stripper solution.

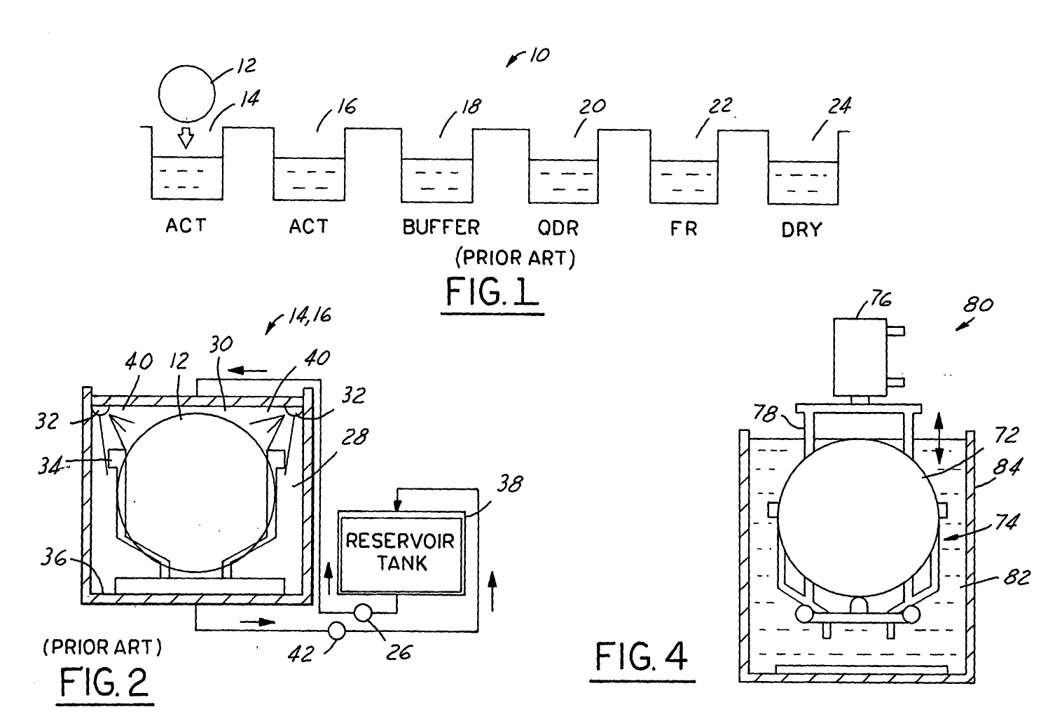

### DETAILED DESCRIPTION OF THE PREFERRED EMBODIMENT

The present invention discloses a wet stripping apparatus for removing unwanted film layers, such as photoresist layers after a bumping process from a wafer surface. The present invention further discloses a method for removing unwanted film layers from a wafer surface by wet stripping.

The apparatus for wet stripping includes a tank body, a wafer holder, and means for reciprocally moving the wafer holder in a stripper solution. The tank body is used for holding a volume of stripper solution in a cavity therein, while the wafer holder is capable of holding at least one and as many as twenty-five wafers therein in a vertical position such that a planar surface of the wafer is parallel to the tank wall of the tank body. The means for reciprocally moving the wafer holder, and therefore the wafers contained therein, in an up-and-down motion while the wafers are immersed in the stripper solution is capable of moving at a frequency of not more than 100 cycle/min. In a preferred embodiment, the frequency is about 60 cycle/min.

The method for removing unwanted film layers, such as photoresist layers from a wafer surface by wet stripping can be carried out by first providing a tank body and a wafer holder, then mounting the wafer holder in the tank body immersed in a stripper solution, and then moving the wafer holder reciprocally in an up-and-down motion with the at least one wafer immersed in the stripper solution at a frequency of not higher than 100 cycle/min.

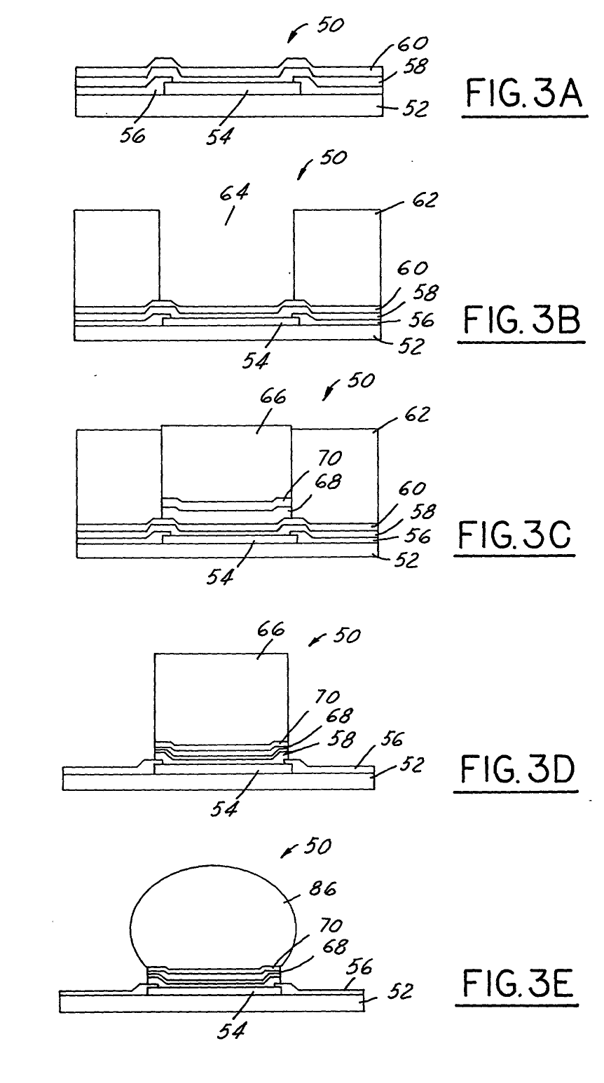

Referring now to FIGS. 3A˜3E wherein a present invention bumping process that utilizes a thick photoresist layer and the subsequent removal of the layer is shown. In FIG. 3A, a present invention semiconductor structure 50 is first provided which is a preprocessed semiconductor substrate 52 with a bond pad 54 formed on top and insulated by an insulating layer 56. On top of the bond pad 54, is then deposited under-bump-metallurgy layers of a Ti layer 58 and a Cu layer 60. The thickness of the Ti layer 58 may be about 0.1 μm, while the thickness of the Cu layer 60 may be about 0.5 μm.

On top of the UBM layers 58,60, is then laminated and patterned with a dry film photoresist layer 62 forming an opening 64 for the bump to be formed. The dry film photoresist layer 62 must have a large thickness, i.e. between about 80 μm and about 200 μm, in order to form a bump that has a sufficient height for the bumping process. In a preferred embodiment of the present invention, the dry film photoresist layer is formed of a polymeric material that has a thickness of about 120 μm. The word “about” used in this writing indicates a range of values that is ±10% of the average value given. The patterning of the dry film photoresist layer 62 is carried out by a standard photolithographic method.

In the next step of the process, a bump material 66 is electroplated to fill the opening 64 defined by the dry film photoresist layer 62. Other bump forming processes such as evaporation, electroless plating, screen printing and stencil printing may also be used in forming the bump 66. It should be noted that seed material layers, such as a Cu seed layer 68 of about 5 μm thick and a Ni seed layer 70 of about 3 μm thickness are sputter deposited into the opening 64 prior to the electroplating process for forming the bump 66 in a solder material such as Pb/Sn. The bump formed has a height that is at least the thickness of the dry film photoresist layer 62 of 120 μm, in the preferred embodiment.

In the next step of the process, for wet stripping the residual photoresist layer 62, a present invention wet stripping tank 80, shown in FIG. 4, is utilized. The wafer that contains the semiconductor structure 50 of FIG. 3C is positioned first in a wafer holder 74, such as that shown in FIG. 4. The wafer 72, or a plurality of wafers 72, is positioned in the wafer holder 74 by engaging slots provided on the inside wall of the holder 74. A typical holder for 300 mm wafers is commonly known as a front open unified pod or FOUP. Other wafer holders such as those widely used for 200 mm diameter wafers of a standard mechanical interface (SMIF) pod may similarly be utilized.

The wafer holder 74, or the FOUP is connected to an air cylinder assembly 76 through connecting rods 78. The air cylinder assembly 76 or any other suitable means, is used to provide reciprocal motion of the wafer holder 74 in an up-and-down motion such that the at least one wafer 72 is exposed to the stripper solution 82 held in the cavity of the tank 84. A suitable frequency for the reciprocating motion of the wafer holder 74 may be less than 100 cycle/min., and preferably less than 60 cycle/min. The wafer 72 is positioned in the wafer holder 74, which is in turn, positioned in the stripper solution 82 in such a way that a planar surface of the wafer 72 is parallel to a vertical tank wall of the wet stripping tank 84. This arrangement was demonstrated as the most efficient way for removing a thick dry film photoresist layer 62 (shown in FIG. 3C) from a wafer surface when the film 62 is covered or held in place by the mushroom-shaped bump 66. However, when the wafer is held on its side such that the structure 50 of FIG. 3C is held on its side, the vertical up-and-down motion of the wafer causes the photoresist layer 62 to separate from the surface of the structure 50. As a result, the photoresist layer 62 is removed producing a structure 50 as shown in FIG. 3D. The structure 50 is then sent through a furnace for a solder reflow process such that the bump 66 forms into a solder ball 86.

The stripper solution 82, shown in FIG. 4, can be any suitable stripper solution. One of such solutions is obtained from the JSR Company of Japan under the trade name of THB™-S2, which contains 96 vol. % dimethyl sulfoxide (DMSO), 3 vol. % tetramethyl ammonia hydroxide (TMAH), and 3 vol. % H₂O. The pH value of the stripper solution is larger than 14.

The present invention novel method for removing unwanted photoresist film layers from a wafer surface after a solder bumping process by wet stripping can be carried out by the steps of first providing a tank body and filling a cavity of the tank body with a volume of a stripper solution, such as one that contains dimethyl sulfoxide. A wafer holder which holds at least one wafer, and as many as twenty-five wafers, in a vertical position is then mounted in the tank body with the planar surfaces of the wafers parallel to a vertical tank wall of the tank body. The wafer holder is mounted in the tank body and immersed in the stripper solution stationarily for a time period of at least 3 min., and preferably for at least 5 min. The wafer holder is then moved reciprocally in an up-and-down motion with the wafers immersed in the stripper solution at a frequency of not higher than 100 cycle/min., and preferably at about 60 cycle/min. The wafer may optionally be soaked in the stripper solution for another 10˜30 sec. after the moving step such that all photoresist films may be loosened from the wafer surface and thus separated.

The present invention wet stripping apparatus and a method for removing unwanted film layers such as photoresist layers from a wafer surface after a solder bumping process have therefore been amply described in the above description and in the appended drawings of FIGS. 3A˜4.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A wet stripping apparatus for removing unwanted film layers from a wafer surface comprising:
a tank body for holding a volume of a stripper solution therein;
a wafer holder for holding at least one wafer therein in a vertical position such that a planar surface of the wafer is parallel to a vertical tank wall of said tank body; and
means for reciprocally moving said wafer holder in an up-and-down motion with said at least one wafer immersed in said stripper solution at a frequency of not more than 100 cycle/min.

2. A wet stripping apparatus for removing unwanted film layers from a wafer surface according to claim 1 further comprising heating means in said tank body for heating said stripper solution.

3. A wet stripping apparatus for removing unwanted film layers from a wafer surface according to claim 1, wherein said wafer holder is a front open unified pod (FOUP) for holding up to 25 wafers.

4. A wet stripping apparatus for removing unwanted film layers from a wafer surface according to claim 1, wherein said wafer holder is a standard mechanical interface (SMIF) pod.

5. A wet stripping apparatus for removing unwanted film layers from a wafer surface according to claim 1, wherein said means for reciprocally moving said wafer holder is an air cylinder assembly.

6. A wet stripping apparatus for removing unwanted film layers from a wafer surface according to claim 1, wherein said means for reciprocally moving said wafer holder is an air cylinder assembly that moves at a frequency of about 60 cycle/min.

7. A wet stripping apparatus for removing unwanted film layers from a wafer surface according to claim 2, wherein said heating means is an electrical heating means.

8. A wet stripping apparatus for removing unwanted film layers from a wafer surface according to claim 1, wherein said stripper solution comprises dimethyl sulfoxide (DMSO).

9. A method for removing unwanted film layers from a wafer surface by wet stripping comprising the steps of:
providing a tank body and filling the tank body with a volume of a stripper solution;
providing a wafer holder holding at least one wafer therein in a vertical position with a planar surface of the wafer parallel to a vertical tank wall of said tank body;
mounting said wafer holder in said tank body immersed in said stripper solution; and
moving said wafer holder reciprocally in an up-and-down motion with said at least one wafer immersed in said stripper solution at a frequency of not more than 100 cycle/min.

10. A method for removing unwanted film layers from a wafer surface by wet stripping according to claim 9 further comprising the step of filling the tank body with a stripper solution that comprises dimethyl sulfoxide (DMSO).

11. A method for removing unwanted film layers from a wafer surface by wet stripping according to claim 9 further comprising the step of filling the tank body with a stripper solution that comprises dimethyl sulfoxide (DMSO) and tetramethyl ammoniumhydroxide (TMAH).

12. A method for removing unwanted film layers from a wafer surface by wet stripping according to claim 9 further comprising the step of mounting said wafer holder in said tank body and soaking said at least one wafer in said stripper solution stationarily for at least 3 min.

13. A method for removing unwanted film layers from a wafer surface by wet stripping according to claim 9 further comprising the step of mounting said wafer holder in said tank body and soaking said at least one wafer in said stripper solution stationarily for at least 3 min and then moving said wafer holder up-and-down at a frequency of not more than 100 cycle/min.

14. A method for removing unwanted film layers from a wafer surface by wet stripping according to claim 9 further comprising the steps of:
rinsing said wafer holder and said at least one wafer in a quick dump rinse (QDR) process; and
spin drying said at least one wafer.

15. A method for removing unwanted film layers from a wafer surface by wet stripping according to claim 9 further comprising the step of moving said wafer holder reciprocally in an up-and-down motion for a length of time sufficient to remove all unwanted film layers from said wafer surface.

16. A method for removing unwanted film layers from a wafer surface by wet stripping comprising the steps of:
providing a tank body and filling the tank body with a volume of a stripper solution;
providing a wafer holder holding at least one wafer therein in a vertical position with a planar surface of the wafer parallel to a vertical tank wall of said tank body;
mounting said wafer holder in said tank body and immersing said at least one wafer stationarily in said stripper solution for a time period of at least 3 min; and
moving said wafer holder reciprocally in an up-and-down motion with said at least one wafer immersed in said stripper solution at a frequency of not more than 100 cycle/min.

17. A method for removing unwanted film layers from a wafer surface by wet stripping according to claim 16 further comprising the step after said moving step of immersing said at least one wafer stationarily in said tank body for a time period of at least 10 sec.

18. A method for removing unwanted film layers from a wafer surface by wet stripping according to claim 16 further comprising the step of filling the tank body with a stripper solution that comprises dimethyl sulfoxide (DMSO).

19. A method for removing unwanted film layers from a wafer surface by wet stripping according to claim 16 further comprising the steps of:
rinsing said wafer holder and said at least one wafer in a quick dump rinse (QDR) process; and
spin drying said at least one wafer.

20. A method for removing unwanted film layers from a wafer surface by wet stripping according to claim 16 further comprising the step of moving said wafer holder reciprocally in an up-and-down motion for a length of time sufficient to remove all unwanted film layers from said wafer surface.
